(19) United States
(12) Patent Application Publication
(10) Pub. No.: US 2011/0076478 A1
(43) Pub. Date: Mar. 31, 2011

(54) DUST-REPELLENT NANOPARTICLE SURFACES

(75) Inventors: Fred Haynes, Memphis, TN (US); Adrian DeKrom, Newbury, OH (US)

(73) Assignee: HUNTER FAN COMPANY, Memphis, TN (US)

(21) Appl. No.: 12/890,987

(22) Filed: Sep. 27, 2010

Related U.S. Application Data
(60) Provisional application No. 61/246,069, filed on Sep. 25, 2009.
(60) Provisional application No. 61/330,711, filed on May 3, 2010.

(51) Int. Cl. B32B 5/00; B05D 3/00; C09D 1/00

(52) U.S. Cl. 428/220; 427/372.2; 427/384; 106/287.1

(57) ABSTRACT

A dust-repellent composition comprising at least one hydrophobic nanoparticle is provided; surfaces having a nanoscale hydrophobic composition are also provided; and processes for making surfaces having a nanoscale hydrophobic composition are also disclosed.

### CROSS-REFERENCE TO RELATED APPLICATIONS

This Non-Provisional patent application claims the benefit of U.S. Provisional Patent Application No. 61/246,069, filed on Sep. 25, 2009, and of U.S. Provisional Patent Application No. 61/330,711, filed on May 3, 2010, each of which are hereby incorporated by reference in their entireties.

### BACKGROUND

1. Field

The present disclosure relates to compositions and processes for producing dust-repellent and sacrificial dust-repellent coatings on articles, especially articles of furniture, wherein a nanoscale hydrophobic composition is applied to the surface of the articles on which the dust-repellent and dust-repellent property is desired, thus creating an engineered surface with less surface area for dust to contact.

2. Description of Related Art

Removing dirt from articles used by humans is important for many reasons, including cleanliness, aesthetic purposes, health-related purposes, and avoiding the spread of contaminating dirt to oneself and others. Not surprisingly, this activity consumes a great deal of time and effort. Washing with water or some other liquid is one way to remove such dirt, yet articles may retain surface dirt even with washing.

The solution to this technical problem is provided by the embodiments characterized in the accompanying claims.

### BRIEF SUMMARY

In one embodiment, the present disclosure provides a dust-repellent composition comprising a hydrophobic nanoparticle dispersed in least one solvent, wherein the composition is free of at least one binder. In one aspect, the hydrophobic nanoparticle comprises hexamethylsilazane-aftertreated fumed silica. In one aspect, the at least one solvent comprises a non-polar solvent. In one aspect, the at least one solvent comprises a polar solvent. In one aspect, the at least one solvent comprises a polar aprotic solvent. In one aspect, the at least one solvent comprises ethanol.

In one embodiment, the present disclosure provides a dust-repellent surface having hydrophobic surface structure, said dust-repellent surface comprising a hydrophobic nanoparticle. In one aspect, the hydrophobic nanoparticle comprises hexamethylsilazane-aftertreated fumed silica. In one aspect, the dust-repellent surface is a sacrificial dust-repellent surface. In one aspect, dust on said dust-repellent surface is reduced by about 60% to about 70%.

In one embodiment, the present disclosure provides a method for producing dust-repellent surfaces having hydrophobic surface structure, the method comprising: dispersing a hydrophobic nanoparticle in at least one solvent, wherein the resulting dispersion is free of at least one binder; applying said hydrophobic nanoparticle dispersed in the at least one solvent to a surface to be treated; allowing said at least one solvent to evaporate; thereby producing a dust-repellent surface having hydrophobic surface structure. In one aspect, the dust-repellent surface produced is a sacrificial dust-repellent surface. In one aspect, the hydrophobic nanoparticle comprises hexamethylsilazane-aftertreated fumed silica. In one aspect, the at least one solvent comprises a non-polar solvent. In one aspect, the at least one solvent comprises a polar solvent. In one aspect, the at least one solvent comprises a polar aprotic solvent. In one aspect, the at least one solvent will not etch the surface to be treated. In one aspect, the solvent comprises ethanol. In one aspect, dust on said dust-repellent surface is reduced by about 60% to about 70%.

Further embodiments, features, and advantages of the present disclosure, as well as the structure and operation of the various embodiments of the present disclosure, are described in detail below with reference to the accompanying drawings.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements.

FIGS. 1A and 1B each show the surface of a fan blade at 40× magnification. FIG. 1A shows control blade number 2, from fan number 2 of TABLE 1 below; FIG. 1B shows treated blade number 2 from fan number 2 of TABLE 1 below. The circular area in each of FIGS. 1A and 1B was selected randomly, and the particles within each circle were counted manually.

FIG. 2 is a graphical depiction of the data of TABLE 1, showing the mean particle dust count for each fan blade (two controls, three treated) of two fans (Fan 1 and Fan 2). The error bars represent the standard deviation.

FIG. 3 is a graphical depiction of the data of TABLE 1, showing the mean particle dust count for the control fan blades and the treated fan blades of each of Fans 1 and 2. The error bars represent the standard deviation.

FIGS. 4A-4D show micrographs of fan blades that were either coated with the composition of the present disclosure (FIGS. 4A and 4C) or not coated (FIGS. 4B and 4D), and then exposed to dust.

FIGS. 5A-5D show micrographs of fan blades that were either coated with Aeroxide® LE 1 (FIGS. 5A and 5C) or with Aerosil R 8200® (FIGS. 5B and 5D), and then exposed to dust.

FIG. 6 shows schematically how the dust-repellent compositions may be applied to a surface using a roller.

FIG. 7A shows a sacrificial dust-repellent surface created by applying the sacrificial dust-repellent composition of the present disclosure to a solid substrate (e.g., the wheel of an automobile), and a layer of dirt (e.g., brake dust) that has accumulated on said sacrificial dust-repellent surface. FIG. 7B shows the facilitated removal of the dirt layer of FIG. 7A, along with some (but not all) of the sacrificial dust-repellent surface, said removal being facilitated by the prior application of the sacrificial dust-repellent composition to the solid substrate.

FIG. 8A is a scanning electron micrograph of a surface coated with the instant composition, at 50,000× magnification; FIG. 8B is a scanning electron micrograph of an equivalent surface that was not coated with the instant composition, at the same level of magnification.

### DETAILED DESCRIPTION

Before the subject disclosure is further described, it is to be understood that the disclosure is not limited to the particular embodiments of the disclosure described below, as variations of the particular embodiments may be made and still fall within the scope of the appended claims. It is also to be understood that the terminology employed is for the purpose of describing particular embodiments, and is not intended to be limiting. Instead, the scope of the present disclosure will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this disclosure belongs.

“Dust” is the general name given to minute, particles having diameters of about less than 500 μm, and may arise from various sources including soil, volcanic eruptions, pollution and other human activities (e.g., burning of carbon-based substances, friction between brake pads and brake rotors in an automobile, etc.), skin cells, plant pollen, textile fibers, animal hair, minerals from soil, arthropod carcasses, etc. The term “dirt” denotes a filthy, unclean, or soiling substance, (e.g., mud, dust, or grime). The terms “dust” and “dirt” are used interchangeably herein.

The theory of dust resistance is related to three key factors: low coefficient of friction; low surface energy; and anti-static properties. Materials with a low coefficient of friction tend to be very smooth, “slippery,” hydrophobic surfaces. Unfortunately, these surfaces are very prone to static charge build-up. Low surface energy is normally imparted by functional groups with low polarity, and anti-static properties are normally generated by materials capable of conducting electric charge. Low surface energy properties and anti-static properties, however, tend to be mutually exclusive. In addition, formulations designed to dissipate static electricity tend to hydrate water, producing a highly hydrophilic surface—water is a terrific adhesive for dust. Thus, producing a dust-repellent surface has required selecting among different unfavorable options.

The Lotus Effect is a well-known technology capable of producing super hydrophobic surfaces. Interestingly, those surfaces are comprised of nanoparticles that are not inherently hydrophobic. The hydrophobic properties are the result of the nanoscale. Importantly, the nanoparticles make possible the production of a super-hydrophobic surface. Equally important, the nanoparticles provide a nano-textured surface that dramatically reduces the surface area available for dust to contact. By reducing the surface contact of a statistical dust particle from about 50% to about 5%, adherence of dust to surfaces treated according to the processes disclosed is reduced dramatically.

Faced with the aforementioned difficulties, the applicants turned to unconventional means for a solution. More than thirty different coating formulations or methods were tested before a successful formulation was achieved. The attempted coating formulations and methods included: anti-static coatings with or without binders (e.g., Staticide, Lycron™ polymer, Teflon® dispersion, SSK polymeric coating, Vecdor nanocoatings, and silicon dioxide nanoparticles); anti-static base materials (e.g., conductive polycarbonate, Static String™, aluminum, Teflon®-taped edges); and highly static base materials (e.g., polypropylene). Only one approach other than that disclosed below produced an appreciable degree of success, but required multiple applications of the formulation.

In one embodiment, the composition and methods of the present disclosure provide dust-resistant and/or sacrificial dust-resistant coatings on articles, thereby facilitating the removal of dust from said articles. Thus, the composition of the present disclosure is applied to articles to provide a coating that facilitates removal of any dust that then accumulates on the coating itself.

By employing the disclosed composition and methods, one may reduce or even forego the not insignificant effort required to clean a wide variety of articles encountered in everyday life.

The present disclosure is directed to producing a dust-repellent composition comprising hydrophobic nanoparticles. In some embodiments, the hydrophobic nanoparticles comprise silicates, fumed silicas, or precipitated silicas, in particular Aerosils®, and more particularly Aerosil® R 8200. The dust-repellent composition may further comprise a solvent. In some embodiments, the solvent is an alcohol, in particular methanol, ethanol, or isopropanol. In some embodiments, the nanoparticle:solvent weight ratio is about 0.1 to about 100, about 0.5 to about 100, about 1 to about 100, about 2 to about 100, or about 5 to about 100. Preferably, said ratio is 1 to 100. In some embodiments, the hydrophobic nanoparticles are added to a solvent with high-shear, high-speed mixing, thereby producing a dispersion of the hydrophobic nanoparticles in the solvent. In some embodiments, the dust-repellent composition is supplied as a dispersion, a dip, a paint, an aerosol, or a spray. Importantly, the composition of the present disclosure lacks any binder; addition of at least one binder to the instant composition will compromise its dust-repellent efficacy.

The present disclosure is also directed to providing dust-repellent surfaces and sacrificial dust-repellent surfaces which have hydrophobic surface structure. In some embodiments, the hydrophobic surface structure comprises elevations and depressions formed by nanoparticles. In some embodiments, the nanoparticles have a fissured structure with elevations and/or depressions in the nanometer range. In some embodiments, the nanoparticles provide a nano-textured surface that dramatically reduces the surface area available for dust to contact. In some embodiments, the surface area available for dust to contact is about 0.5% or less, about 1% or less, about 2% or less, about 3% or less, about 4% or less, about 5% or less, about 6% or less, about 7% or less, about 8% or less, about 9% or less, about 10% or less, about 15% or less, about 20% or less, about 25% or less, or about 30% or less of the total surface area. Preferably, the surface area available for dust to contact is about 0.5% to about 10%, about 2% to about 8%, about 3% to about 7%, about 4% to about 6%, or more preferably about 4.5 to about 5.5%. In some embodiments, the dust-repellent surface is about 0.01 μm to about 50 μm, about 0.01 μm to about 40 μm, about 0.01 μm to about 30 μm, about 0.01 μm to about 20 μm, about 0.01 μm to about 10 μm, about 1 μm to about 10 μm, about 2 μm to about 10 μm, about 3 μm to about 10 μm, about 4 μm to about 10 μm, and preferably about 5 μm to about 10 μm thick.

In some embodiments, application to a surface of the dust-repellent composition, thereby creating a dust-repellent surface, provides a reduction of accumulated dust of up to about 10% or more, up to about 20% or more, up to about 30% or more, up to about 40% or more, up to about 50% or more, up to about 60% or more, up to about 63% or more, up to about 65% or more, up to about 68% or more, up to or about 70% or more, as compared to said surface in the absence of application of said dust-repellent composition.

In some embodiments, the dust-repellent surfaces comprise a dust-resistant coating that is substantially adhered to the article to which it is applied (thus creating a dust-resistant surface), and little to none of said coating is removed or displaced upon cleaning of said article (e.g., with a cloth, a brush, with water or other solvent, ultrasound, or some other form of energy). In some embodiments, said cleaning of said article removes about 0%, about 1% or less, about 2% or less, about 3% or less, about 4% or less, about 5% or less, about 6% or less, about 7% or less, about 8% or less, about 9% or less, or about 10% or less of said dust-resistant coating.

In some embodiments, the sacrificial dust-repellent surfaces comprise a sacrificial dust-resistant coating that is loosely adhered to the article to which it is applied (thus creating a sacrificial dust-resistant surface), and at least some of said coating is removed or displaced (i.e., “sacrificed”) upon cleaning of said article (e.g., with a cloth, a brush, with water or other solvent, ultrasound, or some other form of energy). In some embodiments, said cleaning of said article removes about 5% or more, about 10% or more, about 25% or more, about 50% or more, about 75% or more, about 85% or more, about 90% or more, about 95% or more, about 97% or more, about 99% or more, or about 100% of said sacrificial dust-resistant coating. In some embodiments, the sacrificial dust-repellent surface is about 0.01 μm to about 50 μm, about 0.01 μm to about 40 μm, about 0.01 μm to about 30 μm, about 0.01 μm to about 20 μm, about 0.01 μm to about 10 μm, about 1 μm to about 10 μm, about 2 μm to about 10 μm, about 3 μm to about 10 μm, about 4 μm to about 10 μm, and preferably about 5 μm to about 10 μm thick.

The dust-repellent and sacrificial dust-repellent surfaces of the disclosure, the composition for making said surfaces, and the processes for producing said surfaces are described by way of example below, but there is no intention to limit the surfaces of the disclosure, the compositions for making said surfaces, or the process of the disclosure to the embodiments given by way of example.

The present disclosure provides a dust-repellent composition for creating dust-repellent and/or sacrificial dust-repellent surfaces, the composition comprising hydrophobic nanoparticles. Preferably, the average nanoparticle size is between about 5 nm and 50 nm. More preferably, the nanoparticles preferably have an average particle size of between about 10 nm and about 20 nm, and most preferably they have an average particle size of between about 11 nm and about 13 nm. The nanoparticles preferably have a BET surface area of from about 20 to about 1,000 m²/g. More preferably, the nanoparticles have a BET surface area of from about 50 to about 200 m²/g, and most preferably the nanoparticles have a BET surface area of from about 135 to about 185 m²/g. The tamped density of the nanoparticles, in accordance with DIN EN ISO 787/11, is from about 20 to about 230 g/L, preferably from about 90 to about 200 g/L, and most preferably from about 130 to about 150 g/L.

The nanoparticles used may be of a wide variety of compounds from many branches of chemistry or from the natural world. The nanoparticles preferably have at least one material selected from silicates, doped silicates, minerals, metal oxides, silicas, polymers, and coated metal powders. The particles may themselves be hydrophobic (e.g. particles comprising PTFE), or the particles used may have been hydrophobized. The particles may be hydrophobized in a manner known to the skilled worker. Preferably, the nanoparticles possess hydrophobic properties as a result of treatment with at least one compound selected from the group consisting of the alkyl silanes, fluoroalkylsilanes, perfluoroalkylsilanes, paraffins, waxes, fatty esters, functionalized long-chain alkane derivatives, disilazanes, and alkyl disilazanes. Particularly suitable nanoparticles are hydrophobized fumed silicas, known as Aerosils. Most preferably the nanoparticles are Aerosil® R 8200 (CAS No. 68909-20-6, sold in Europe as Aeroxide® LE 1, available from Evonik Degussa).

The dust-repellent composition further comprises at least one solvent. Preferably, the at least one solvent is one in which the hydrophobic nanoparticles may be dispersed (e.g., via mechanical or ultrasonic means). Suitable solvents may be polar (polar aprotic or polar protic), or non-polar, organic or inorganic. In some embodiments, the solvent has a dielectric constant of about 5 or greater, about 10 or greater, about 15 or greater, about 20 or greater, about 25 or greater, about 30 or greater, or about 40 or greater. In some embodiments, the solvent has a dipole moment (in Debye) of about 0.0 or greater, about 0.5 or greater, about 1.0 or greater, 1.5 or greater, 2.0 or greater, 2.5 or greater, 3.0 or greater, 3.5 or greater, or about 4.0. Preferably, the vapor pressure of the at least one solvent is greater than that of water at the same temperature and pressure. Non-polar solvents suitable for use with the present invention include, but are not limited to, pentane, cyclopentane, hexane, cyclohexane, benzene, toluene, 1,4-dioxane, chloroform, diethyl ether, and combinations thereof. Polar aprotic solvents suitable for use with the present invention include, but are not limited to, dichloromethane, tetrahydrofuran, ethyl acetate, acetone, dimethylformamide, acetonitrile, dimethylsulfoxide, and combinations thereof. Polar protic solvents suitable for use with the present invention include, but are not limited to, methanol, ethanol, n-propanol, isopropanol, a butanol, a pentanol, acetone, methyethylketone, ethylacetate, acetonitrile, tetrahydrofuran, dimethylformamide, dimethylsulfoxide, and combinations thereof. Preferably, the solvent is a polar solvent. In some embodiments, the polar solvent has a boiling point of about 200° C. or less, about 175° C. or less, about 150° C. or less, about 125° C. or less, or about 100° C. or less. Preferably, the solvent is an alcohol, including but not limited to methanol, ethanol and isopropanol. Preferably, the solvent is about 70%, about 80%, about 90%, about 95%, about 97%, about 99%, or about 100% ethanol. More preferably, the solvent is 100% ethanol. Preferably, the solvent does not dissolve, damage, etch, or otherwise compromise the surface of an article to be treated with the disclosed dust-repellent composition (e.g., coatings applied prior to application of the dust-repellent composition of the present disclosure, including but not limited to varnishes, paints, glues, waxes, ultraviolet-resistant coatings, sealants, etc.), or such dissolving, etc. is minimized.

Preferably, the dust repellent composition is free of binder (e.g., without intending to be limited thereby, isopropyl isostearate, isopropyl myristate, liquid lanolin, silicone oil, ethoxylated pentaerytholtetraacrylate, oligoether acrylates, resins, etc., or combinations thereof), as adding at least one binder to the dust repellent composition defeats the composition's dust-repellent properties.

Depending on the surface to which the dust-repellent composition is applied, and also depending on the amount of the composition applied, transparent dust-resistant surfaces may be obtained.

The present disclosure also provides dust-repellent and sacrificial dust-repellent surfaces (produced with the dust-repellent composition of the instant disclosure) which have a hydrophobic surface structure. The hydrophobic surface structure produced by the dust-repellent composition of the instant disclosure is comprised of uneven elevations and depressions, wherein the uneven elevations and depressions are formed by particles comprised of nanoparticles. The uneven elevations and depressions produce a dust-repellent property not achievable with more traditional coatings. When dust particles settle on a dust-repellent or sacrificial dust-repellent surface of the present disclosure, their contact points with said surface are limited by virtue of the surface's unevenness. By providing fewer contact points for dust, the attractive forces are minimized from both a static charge and standard adhesion perspective. Consequently, the dust adheres less effectively than it would to more traditional coatings. The result is a dust-repellent or sacrificial dust-repellent surface. Finally, because the dust-repellent and sacrificial dust-repellent surfaces of the present disclosure are highly hydrophobic, moisture-enhanced adhesion is simultaneously minimized.

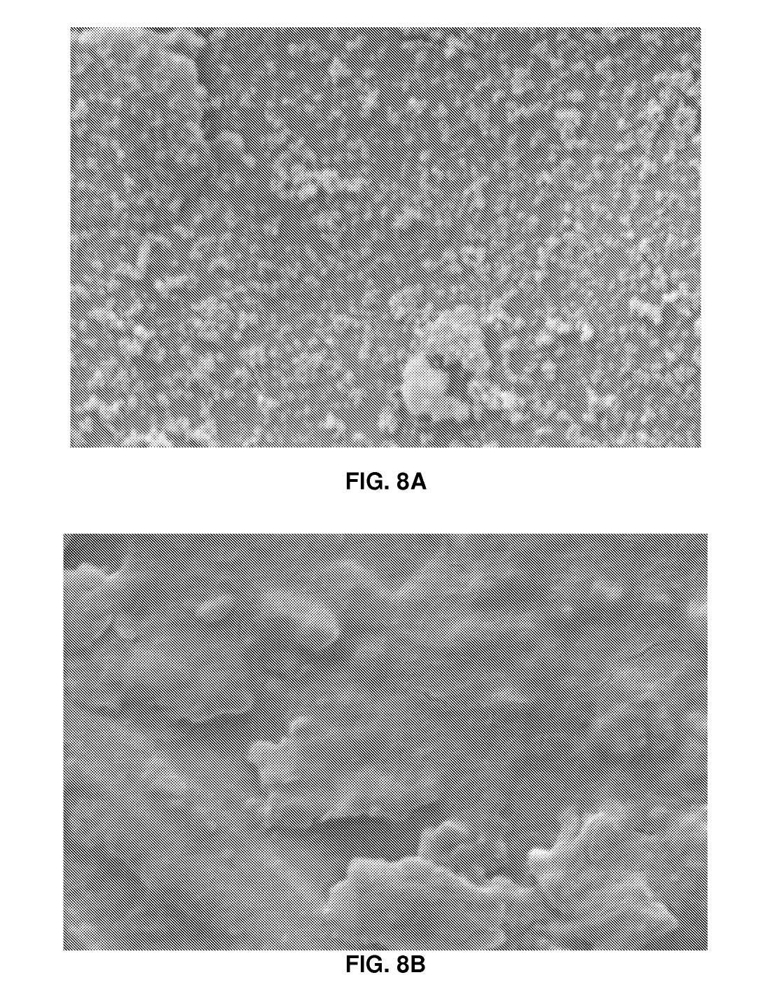

The dust-repellent and sacrificial dust-repellent surfaces of the disclosure are preferably produced by the processes of the disclosure, which employ the aforementioned dust-repellent composition of the disclosure. These processes of the disclosure produce dust-repellent and/or sacrificial dust-repellent surfaces having hydrophobic surface structure. The hydrophobic surface structure is comprised of elevations and depressions (as shown in FIG. 8A), wherein the elevations and depressions are formed by particles that are comprised of nanoparticles overlying the surface, and is distinguished by the fact that neither the particles nor the nanoparticles comprising the particles are secured to the surface by physical or chemical methods (compare with uncoated surface, shown in FIG. 8B).

The nanoparticles used to produce the dust-repellent and sacrificial dust-repellent surfaces of the disclosure may be of a wide variety of compounds from many branches of chemistry or from the natural world. The nanoparticles preferably have at least one material selected from silicates, doped silicates, minerals, metal oxides, silicas, polymers, and coated metal powders. The particles may themselves be hydrophobic (e.g. particles comprising PTFE), or the particles used may have been hydrophobized. The hydrophobization of the particles may take place in a manner known to the skilled worker.

Preferably, the nanoparticles possess hydrophobic properties as a result of treatment with at least one compound selected from the group consisting of the alkyl silanes, fluoroalkylsilanes, perfluoroalkylsilanes, paraffins, waxes, fatty esters, functionalized long-chain alkane derivatives, disilazanes, and alkyl disilazanes. Particularly suitable nanoparticles are hydrophobized fumed silicas, known as Aerosils. Most preferably the nanoparticles are Aerosil® R 8200 (also known as Aeroxide® LE 1, available from Evonik Degussa).

Preferably, the process for producing dust-repellent surfaces and sacrificial dust-repellent surfaces of the present disclosure comprises application of the dust-repellent composition of the disclosure to a surface, wherein said application is via spin coating, immersion (“dip”) coating, dip-spin coating, flow coating, roll coating (direct and reverse), spray coating (including conventional air atomization; airless atomization; air-assisted airless atomization; high volume, low pressure air-atomizing spray, flame spray, electrostatic spray, and rotary atomization), slide die coating, slot die coating, bar coating, gravure coating, curtain coating, air knife coating, meniscus coating, metering rod (Meyer rod) coating, knife over roll (“gap”) coating, flexographic printing, screen printing, bead coating, or brush-coating. In one embodiment, the dust-repellent composition may be pressurized, and the pressurized composition may be sprayed onto a surface (e.g., as an aerosol). In another embodiment, the dust-repellent composition may be supplied as a dispersion comprising solvent, which may be applied to a surface in any suitable fashion (e.g., via dipping an article comprising a surface to be treated, via transferring the dispersion to the surface as with a brush or a roller coated with the dispersion, via spraying the surface of an article to be treated, or combinations thereof).

The compositions and processes of the disclosure provide excellent results in the production of dust-repellent and sacrificial dust-repellent surfaces on planar and/or non-planar objects. Examples of planar and/or non-planar objects to which the compositions of the disclosure could be applied to produce a dust-repellent or sacrificial dust-repellent surface of the disclosure include, but are not limited to, fan blades, table tops, bookcases, turned table legs, turned railings, chair backs, sculptures, and the like. Further non-limiting examples of objects to which the compositions of the disclosure could be applied to produce a dust-repellent or sacrificial dust-repellent surface of the present disclosure include: electronics (e.g., televisions, computers, video displays, DVD players, etc.); furniture; blinds, shades, drapes; artificial plants; lighting fixtures/chandeliers; kitchens (e.g., countertops, refrigerators, freezers, microwave and conventional ovens, equipment therein, etc.); bathrooms (e.g., mirrors, toilets, showers, bathtubs, fixtures, grout, tiles, etc.); baseboards; hardwood/laminate floors; decking; chimney flues; HVAC systems (e.g., ductwork, registers/vents, etc.); windows; garbage cans; painted surfaces (e.g., wood, metal, brick, plastic, etc.); exterior lighting; automobiles, motorcycles, ATVs, and other motor vehicles. (e.g., windshields, painted surfaces, upholstery, interiors, exhaust systems, engines, wheels, tires, etc.); boats (e.g., painted surfaces, upholstery, interiors, motor, sails, hulls, etc.); sporting goods (e.g., golf balls, skis, surfboards, frisbees, bicycles, etc.); shoes; optics (e.g., prescription and non-prescription eyewear, camera and other lenses, etc.); dry-erase boards (e.g., whiteboards); gun barrels; books; industrial facilities and supplies/equipment therein (e.g., sawmills, mines, machine shops, etc.); industrial conveyance; clean rooms (e.g., as used in semiconductor manufacturing); polymer surfaces; hospital equipment; and the like.

The examples below are intended to provide further description of the compositions of the disclosure, the surfaces of the disclosure, and the process for producing the surfaces, without limiting the disclosure to these embodiments

### Example 1

One hundred parts 100% ethanol (Tecsol C Anhydrous, Ashland Chemical) was added to a container and subjected to high-speed mixing with a high-shear mixer (approximately 10,000 r.p.m.) to produce a vortex. One part Aerosil® R 8200 (Aeroxide® LE 1; hexamethylsilazane-aftertreated fumed silica) was added slowly into the vortex, and the combination was mixed until a uniform dispersion was achieved, thus creating a dust-repellent composition. Aerosil® R 8200 tends to agglomerate, so a high-shear mixer is recommended. Slow addition of the solids to the ethanol vortex yielded optimal results. After mixing, the dispersion was milky-white in appearance; the container was sealed to prevent evaporation and/or contamination. As will be appreciated by those having ordinary skill in the art, additional components may be added to the dispersion. Without intending to be limited thereby, optical brighteners (e.g., stilbenes, umbelliferone, coumarins, imidazolines, diazoles, triazoles, benzoxazolines, etc.) may be added to the dispersion in amounts known to those of ordinary skill in the art, for quality-control purposes. Adding optical brighteners facilitates the monitoring and evaluation of coating quality (e.g., the degree and consistency (evenness) of coating, under an ultraviolet lamp).

### Example 2

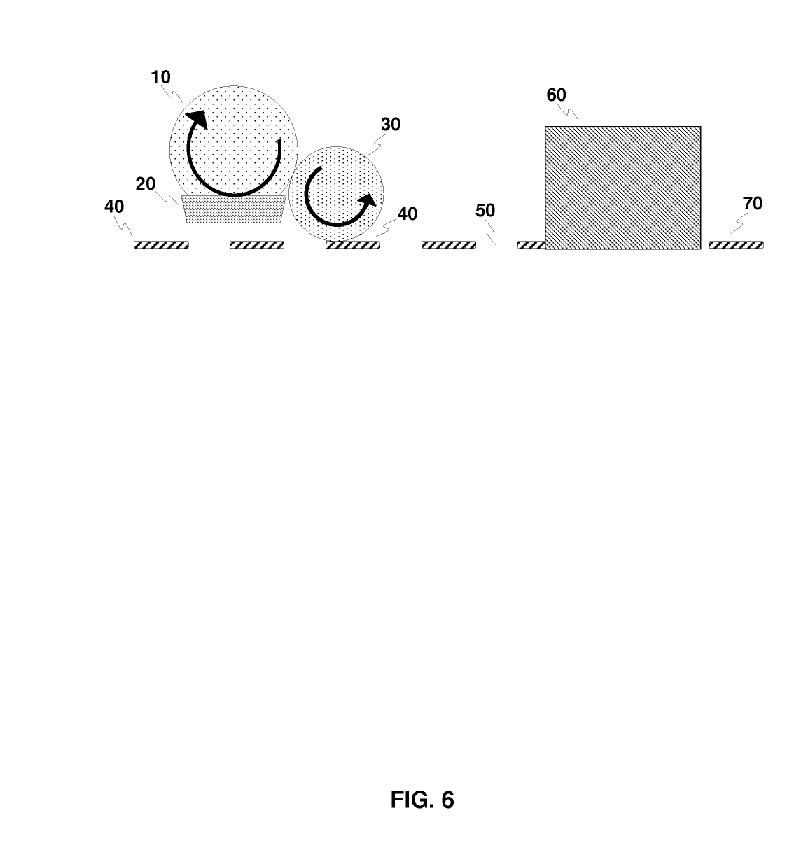

The dispersion of EXAMPLE 1 was applied to the surface of a fan blade using a roller. Referring to FIG. 6, a first roller (10) is at least partially immersed in a trough (20), wherein the trough (20) contains a dust-repellent composition (e.g., the dust-repellent composition of EXAMPLE 1). The first roller (10) is positioned with respect to the trough (20) so that rotation of the first roller (10) through the dust-repellent composition contained within the trough (20) at least partially coats the first roller with the dust-repellent composition. Without intending to be limited thereby, the first roller (10) may be a ferrous or non-ferrous metal (or other suitable materials known in the art) coated with chrome or other suitable materials known in the art to impart an even coating. The first roller (10) is positioned with respect to a second roller (30) so that rotation of the first roller (10) may transfer a sufficient amount of the dust-repellent composition to the second roller (30). The second roller (30) may be made of silicone or urethane with a Shore A scale durometer of between about 40 to about 70, or other suitable materials known in the art. The first and second rollers (10 & 30, respectively) rotate in opposite directions with respect to one another (e.g., clockwise and counterclockwise, respectively, as indicated) so that at least one surface (40) conveyed along transport means (50) may come into contact with the second roller (30), whereupon the second roller (30) at least partially coats the at least one surface (40). The at least one surface (40) so coated may optionally be transported to a drying means (60), which drying means may supply forced air, heated air, vacuum, or a combination thereof. If not transported to a drying means (60), the at least one surface (40) so coated may be allowed to dry at ambient temperature and pressure. Whether dried actively, as with drying means (60), or passively, as with ambient temperature and pressure, the result is a dust-repellent or sacrificial dust-repellent surface (70).

### Example 3

The dispersion of EXAMPLE 1 was applied to the surface of a fan blade by spray application in such an amount that the dust repellent surface obtained by spray application and subsequent drying completely coated the fan blade surface but did not produce a haze as compared with non-treated fan blades. After spray application, the fan blades were air-dried for two minutes at room temperature. As will be appreciated by those of ordinary skill in the art, items so coated could also be dried at elevated temperature, under forced air, under vacuum, or with a combination thereof.

### Example 4

The dispersion of EXAMPLE 1 was applied to the surface of a fan blade by soaking a sponge brush in the dispersion and then using the brush to apply the dispersion to the blade. The dispersion was applied in such an amount that the thickness of the dust repellent surface obtained by brush application and subsequent drying was about 1 to about 1000 nm. After brush application of the dispersion, the fan blades were air-dried for two minutes at room temperature. As will be appreciated by those of ordinary skill in the art, items so coated could also be dried at elevated temperature, under forced air, under vacuum, or with a combination thereof.

### Example 5

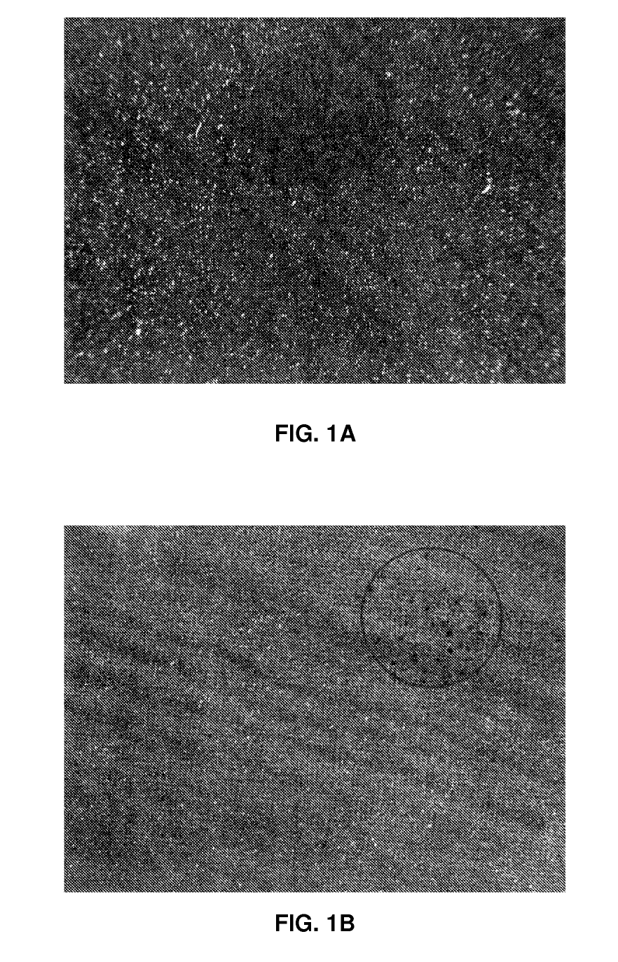

Fan blades bearing dust-repellent surfaces were prepared as explained in EXAMPLE 2 (roller application), and then mounted on a fan. Each of two fans comprised three fan blades with dust-repellent surfaces of the disclosure (see, e.g., FIG. 1B), and two untreated fan blades (see, e.g., FIG. 1A) as controls. Each of the two fans was mounted in a testing chamber and set to rotate at medium speed. The dust used was ISO 12103-1 A2 Arizona Test Dust (fine grade, nominal 0-80 μm particle size with a bi-modal distribution having peaks at about 4 μm and about 20 μm particle size), and was introduced into the chamber via compressed air to ensure that the dust particles were airborne. The fan blades were removed for microscopic analysis one day later.

Each fan blade was imaged three separate times at 40× magnification, at three separate and non-overlapping locations. Examples of the images are provided in FIGS. 1A and 1B. The dust particles evident in each viewing field were counted and recorded, and the data are provided in TABLE 1 below (“S.D.” denotes standard deviation).

TABLE 1

| | | | Mean | |
|---|---|---|---|---|
| | | Dust | Dust | |
| Fan | | Particle | Particle | |
| No. | Blade | Count | Count | S.D. |
| 1 | Control 1 | 116 | 108.00 | 14.73 |
| | | 117 | | |
| | | 91 | | |
| | Control 2 | 95 | 98.33 | 9.45 |
| | | 109 | | |
| | | 91 | | |
| | Treated 1 | 48 | 38.00 | 11.79 |
| | | 25 | | |
| | | 41 | | |
| | Treated 2 | 43 | 44.67 | 5.69 |
| | | 51 | | |
| | | 40 | | |
| | Treated 3 | 27 | 32.67 | 5.51 |
| | | 33 | | |
| | | 38 | | |
| 2 | Control 1 | 138 | 128.33 | 10.02 |
| | | 118 | | |
| | | 129 | | |
| | Control 2 | 181 | 147.00 | 29.60 |
| | | 133 | | |
| | | 127 | | |
| | Treated 1 | 15 | 17.33 | 5.86 |
| | | 13 | | |
| | | 24 | | |
| | Treated 2 | 47 | 54.67 | 17.79 |
| | | 42 | | |
| | | 75 | | |
| | Treated 3 | 56 | 58.00 | 4.36 |
| | | 63 | | |
| | | 55 | | |

As shown by TABLE 1, application of the dust-repellent composition to produce a dust-repellent surface caused a dramatic reduction in accumulated dust: the mean dust particle count for fan blades treated with the dust-repellent composition (Treated 1, 2, 3) for both fans (Fan. Nos. 1 & 2) was significantly lower than the mean dust particle count for the non-treated fan blades (Control 1 & 2), for both fans.

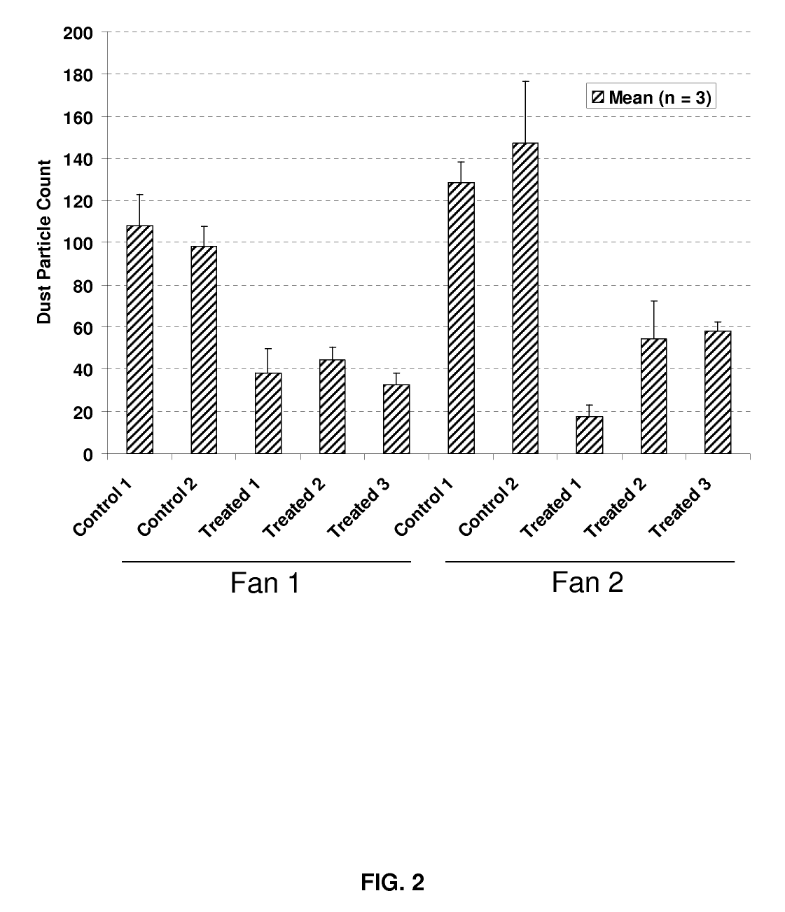

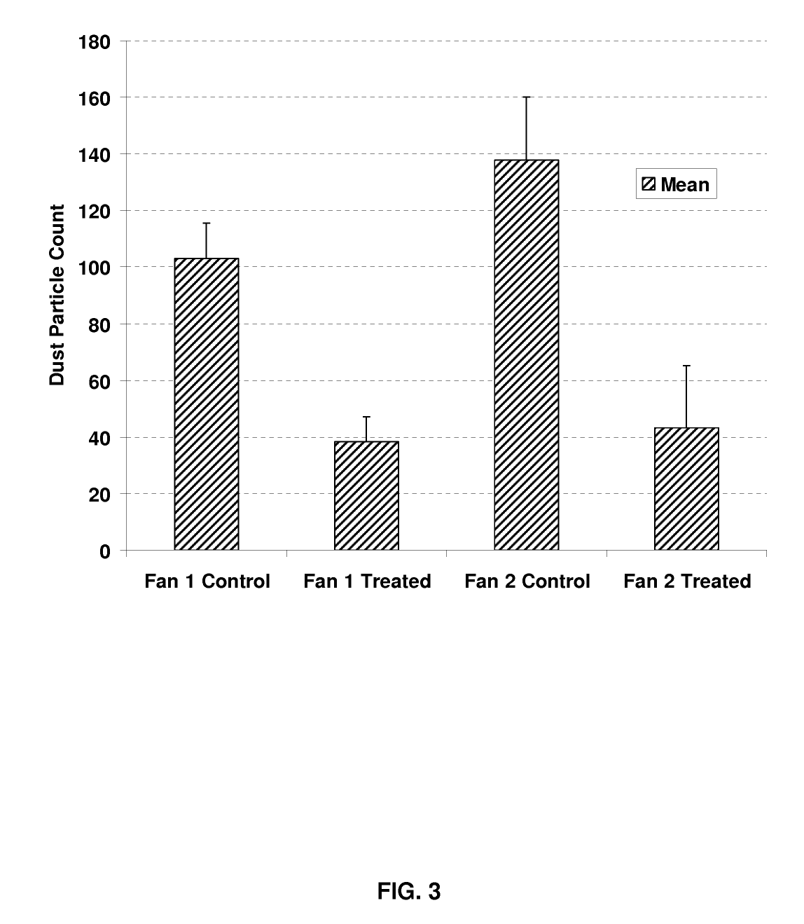

As shown in TABLE 1, and in FIGS. 2 and 3, which provide graphical representations of the data of TABLE 1, fan blades treated with the dust-repellent composition of the disclosure demonstrated a dramatic and statistically significant reduction in the amount of dust particles counted. The data from TABLE 1 for each blade of each fan was pooled and averaged, and the results are shown graphically in FIG. 3. The control blades of Fans 1 and 2 averaged about 105.6 particles (±5.01, S.E.M.) and 137.67 particles (±9.08, S.E.M.) per counting field, respectively, while the treated blades of Fans 1 and 2 averaged about 38.44 particles (±2.93, S.E.M.) and about 43.33 particles (±7.26, S.E.M.) per counting field (“S.E.M.” denotes standard error of the mean). The control blades averaged 120.42 particles per counting field (±7.18, S.E.M.), while the treated blades averaged 40.89 particles per counting field (±3.85, S.E.M.). Thus, treatment of fan blades by the process of the disclosure with the dust-repellent composition of the disclosure reduced the amount of dust particles accumulated by about 63.6% (±0.3%) for Fan 1 to about 68.5% (±0.5%) for Fan 2, or about 66.0% (±0.6%) overall, as compared with fan blades that were not treated with the dust-repellent composition and so did not bear a dust-repellent surface.

### Example 6

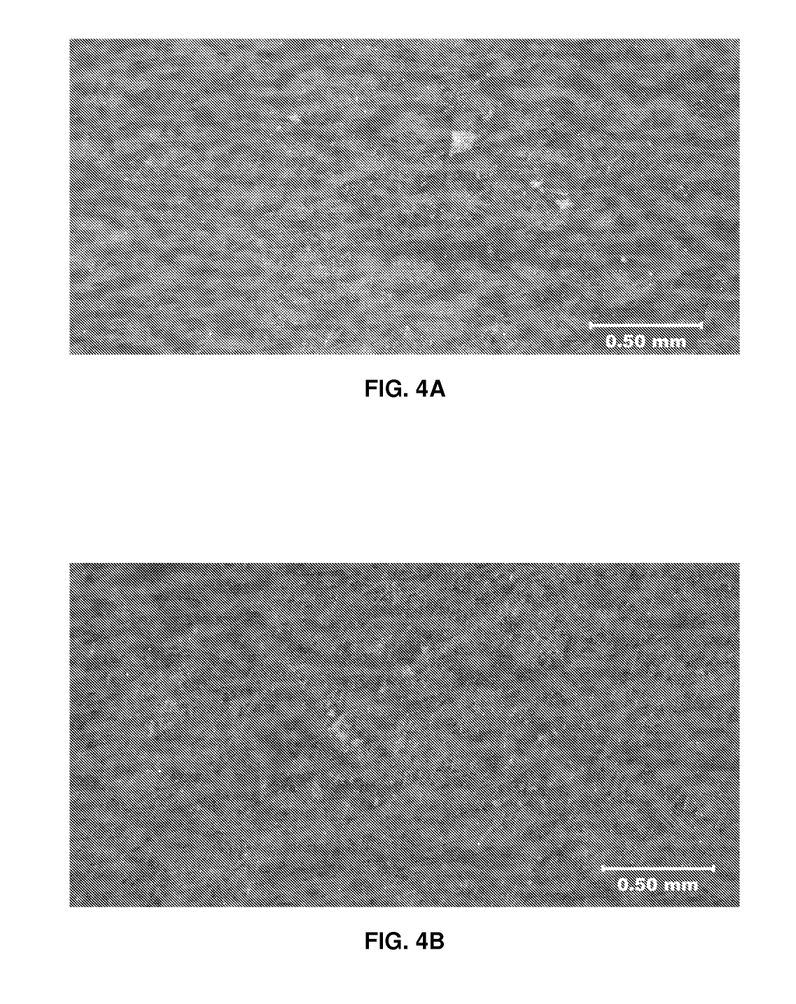

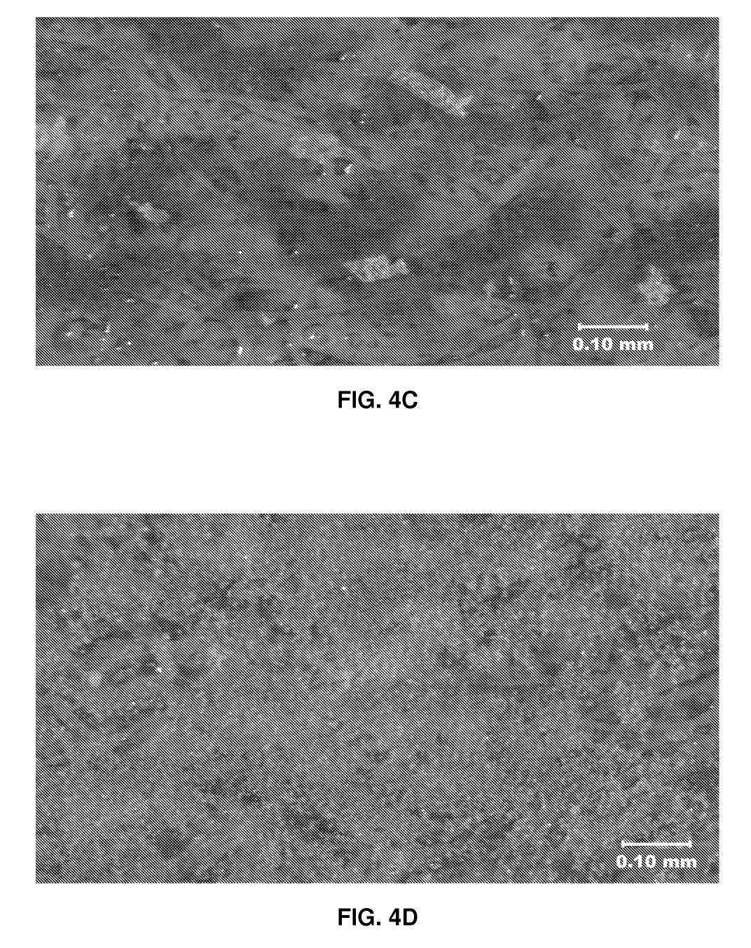

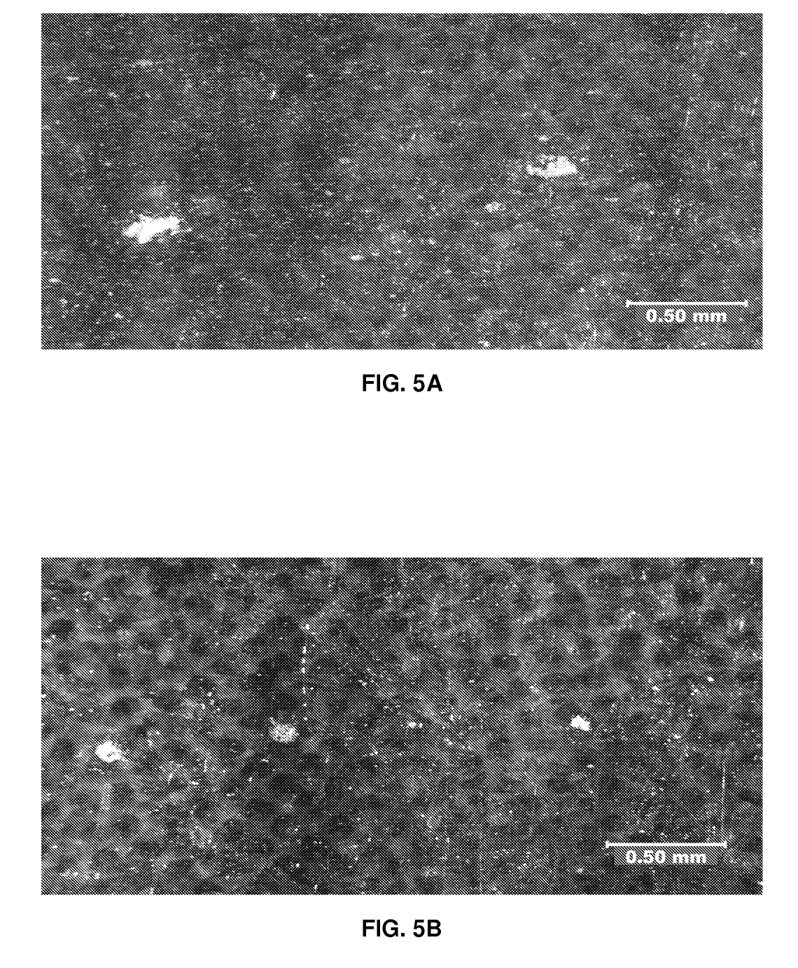

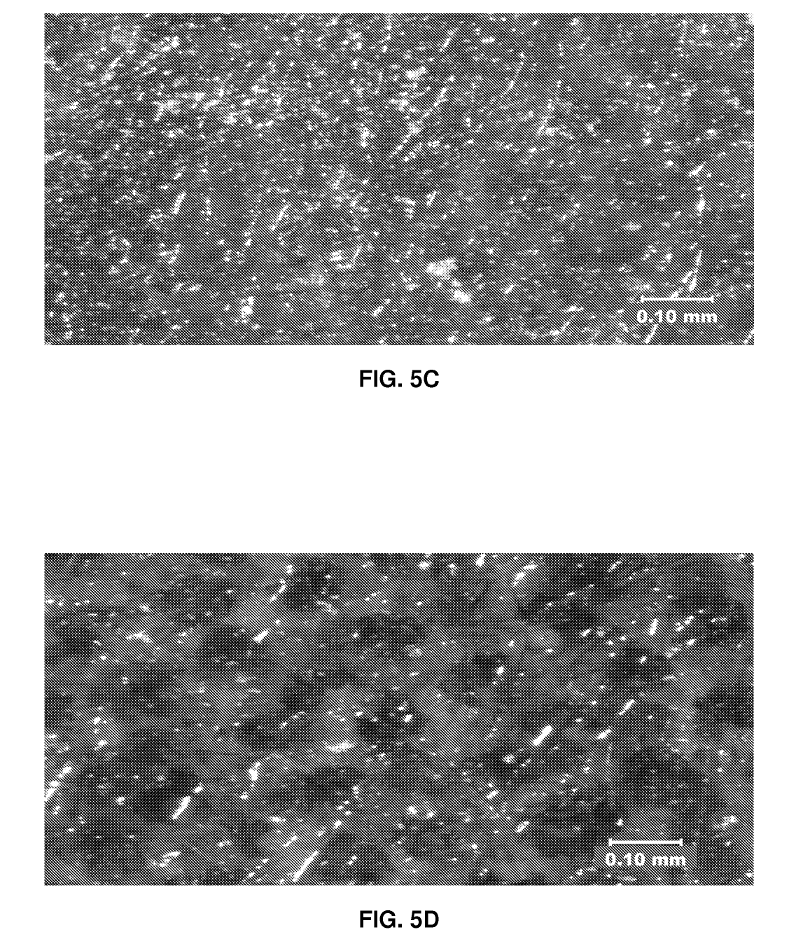

Fan blades bearing dust-repellent surfaces were prepared as explained in EXAMPLE 3 (spray application), using either Aerosil® R 8200 or Aeroxide® LE 1, and then mounted on a fan. Each of two fans comprised three fan blades with dust-repellent surfaces of the disclosure, and two untreated fan blades as controls. Each of the two fans was mounted in a testing chamber and set to rotate at medium speed. The dust used was ISO 12103-1 A2 Arizona Test Dust (fine grade, nominal 0-80 μm particle size with a bi-modal distribution having peaks at about 4 μm and about 20 μm particle size), and was introduced into the chamber via compressed air to ensure that the dust particles were airborne. The fan blades were removed for microscopic analysis about 24 hours later. FIG. 4A shows a fan blade spray-coated with Aerosil® R 8200, and FIG. 4C shows a higher-magnification view of that same blade; FIG. 4B shows a control fan blade not coated with the disclosed dispersion, and FIG. 4D shows a higher-magnification view of that same blade. FIG. 5A shows a fan blade spray-coated with Aeroxide® LE 1, and FIG. 5C shows a higher-magnification view of that same blade; FIG. 5B shows a fan blade spray-coated with Aerosil® R 8200, and FIG. 5D shows a higher-magnification view of that same blade. As shown in FIGS. 4A-4D and 5A-5D, the control fan blades (FIGS. 4B and 4D) displayed a large population of very small dust particles. By contrast, the coated blades (FIGS. 4A, 4C, and 5A-5D) displayed much fewer small particles and instead showed discrete particles of larger size. There was little to no appreciable difference between the blades coated with Aerosil® R 8200 (FIGS. 4A, 4C, 5B, and 5D) and Aeroxide® LE 1 (FIGS. 5A and 5C).

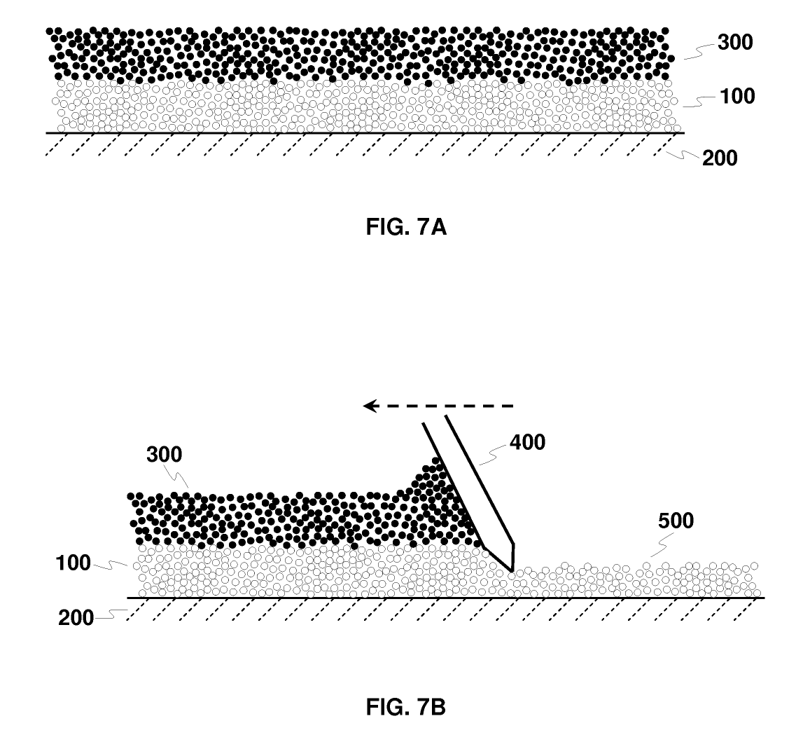

Referring to FIG. 7A, a sacrificial dust-repellent composition of the present disclosure is applied to a solid substrate (200), producing a sacrificial dust-repellent surface (100). Without intending to be limited thereby, examples of said substrate (200) may include electronics (e.g., televisions, computers, video displays, DVD players, etc.); furniture; blinds, shades, drapes; artificial plants; lighting fixtures/chandeliers; kitchens (e.g., countertops, refrigerators, freezers, microwave and conventional ovens, equipment therein, etc.); bathrooms (e.g., mirrors, toilets, showers, bathtubs, fixtures, grout, tiles, etc.); baseboards; hardwood/laminate floors; decking; chimney flues; HVAC systems (e.g., ductwork, registers/vents, etc.); windows; garbage cans; painted surfaces (e.g., wood, metal, brick, plastic, etc.); exterior lighting; automobiles, motorcycles, ATVs, and other motor vehicles. (e.g., windshields, painted surfaces, upholstery, interiors, exhaust systems, engines, wheels, tires, etc.); boats (e.g., painted surfaces, upholstery, interiors, motor, sails, hulls, etc.); sporting goods (e.g., golf balls, skis, surfboards, frisbees, bicycles, etc.); shoes; optics (e.g., prescription and non-prescription eyewear, camera and other lenses, etc.); dry-erase boards (e.g., whiteboards); gun barrels; books; industrial facilities and supplies/equipment therein (e.g., sawmills, mines, machine shops, etc.); industrial conveyance; clean rooms (e.g., as used in semiconductor manufacturing); polymer surfaces; and hospital equipment. Because the sacrificial dust-repellent surface (100) substantially covers said substrate (200), any dust or dirt (300) that accumulates will accumulate upon the sacrificial dust-repellent surface (100).

As shown in FIG. 7B, removal of any dust or dirt (300) accumulated upon the sacrificial dust-repellent surface (100) is accomplished easily by virtually any removal means (400) (e.g., with a cloth, a brush, with water or other solvent, ultrasound, or some other form of energy). As shown in FIG. 7B, movement of the removal means (400) in the direction of the dashed arrow lifts the dirt (300) along with a portion of the sacrificial dust-repellent surface (100), although a portion of the sacrificial dust-repellent surface (500) remains upon the substrate (100) despite said cleaning with removal means (400). By virtue of the sacrificial dust-repellent surface's dust-repellent properties, and by virtue of its loose adherence to the substrate (200), the sacrificial dust-repellent surface (100) greatly facilitates the removal of any accumulated dust or dirt (300). The removal of accumulated dust or dirt from a substrate is substantially more difficult in the absence of prior application of the sacrificial dust-repellent composition to form a sacrificial dust-repellent surface on the substrate.

All references cited in this specification are herein incorporated by reference as though each reference was specifically and individually indicated to be incorporated by reference. The citation of any reference is for its disclosure prior to the filing date and should not be construed as an admission that the present disclosure is not entitled to antedate such reference by virtue of prior invention.

It will be understood that each of the elements described above, or two or more together may also find a useful application in other types of methods differing from the type described above. Without further analysis, the foregoing will so fully reveal the gist of the present disclosure that others can, by applying current knowledge, readily adapt it for various applications without omitting features that, from the standpoint of prior art, fairly constitute essential characteristics of the generic or specific aspects of this disclosure set forth in the appended claims. The foregoing embodiments are presented by way of example only; the scope of the present disclosure is to be limited only by the following claims.

What is claimed is:

1. A dust-repellent composition comprising a hydrophobic nanoparticle dispersed in least one solvent, wherein the composition is free of at least one binder.

2. The composition of claim 1, wherein the hydrophobic nanoparticle comprises hexamethylsilazane-aftertreated fumed silica.

3. The composition of claim 2, wherein the nanoparticle:solvent weight ratio is about 1 to about 100.

4. The composition of claim 3, wherein the at least one solvent comprises a non-polar solvent.

5. The composition of claim 3, wherein the at least one solvent comprises a polar solvent.

6. The composition of claim 5, wherein the solvent comprises ethanol.

7. The composition of claim 5, wherein the at least one solvent comprises a polar aprotic solvent.

8. A dust-repellent surface having hydrophobic surface structure, said dust-repellent surface comprising a hydrophobic nanoparticle.

9. The dust-repellent surface of claim 8, wherein the hydrophobic nanoparticle comprises hexamethylsilazane-aftertreated fumed silica.

10. The dust-repellent surface of claim 9, wherein said dust-repellent surface is about 1 μm to about 10 μm thick.

11. The dust-repellent surface of claim 10, wherein said dust-repellent surface is a sacrificial dust-repellent surface.

12. The dust-repellent surface of claim 8, wherein dust on said dust-repellent surface is reduced by about 60% to about 70%.

13. A method for producing dust-repellent surfaces having hydrophobic surface structure, the method comprising:
a) dispersing a hydrophobic nanoparticle in at least one solvent, wherein the resulting dispersion is free of at least one binder;
b) applying said hydrophobic nanoparticle dispersed in the at least one solvent to a surface to be treated;
c) allowing said at least one solvent to evaporate;
thereby producing a dust-repellent surface having hydrophobic surface structure.

14. The method of claim 13, wherein the dust-repellent surface produced is a sacrificial dust-repellent surface.

15. The method of claim 13, wherein the hydrophobic nanoparticle comprises hexamethylsilazane-aftertreated fumed silica.

16. The method of claim 15, wherein the nanoparticle:solvent weight ratio of said dispersion is about 1 to about 100.

17. The method of claim 16, wherein the at least one solvent comprises a non-polar solvent.

18. The method of claim 16, wherein the at least one solvent comprises a polar solvent.

19. The method of claim 18, wherein the at least one solvent comprises a polar aprotic solvent.

20. The method of claim 16, wherein the at least one solvent will not etch the surface to be treated.

21. The method of claim 20, wherein the at least one solvent comprises ethanol.

22. The method of claim 15, wherein dust on said dust-repellent surface is reduced by up to about 70%.

23. The dust-repellent surface of claim 22, wherein said dust-repellent surface is about 1 μm to about 10 μm thick.

24. A method for reducing the accumulation of dust on an object, the method comprising:
a) dispersing a hydrophobic nanoparticle in at least one solvent, wherein the resulting dispersion is free of at least one binder;
b) applying said hydrophobic nanoparticle dispersed in the at least one solvent to the object;
c) allowing said at least one solvent to evaporate;
thereby producing an object having a dust-repellent surface,
wherein after 24 hours said object has a reduction of dust accumulation of up to about 70% as compared to said object without said dust-repellent surface.

25. The method of claim 24, wherein dust on said dust-repellent surface is reduced by up to about 50%.

26. The method of claim 24, wherein said object is a fan blade.
